(19) United States
(12) Patent Application Publication
(10) Pub. No.: US 2025/0013883 A1
(43) Pub. Date: Jan. 9, 2025

(54) PLANNING FOR AGENT CONTROL USING RESTART-AUGMENTED LOOK-AHEAD SEARCH

(71) Applicant: X Development LLC, Mountain View, CA (US)

(72) Inventor: Matthew L. Ginsberg, Eugene, OR (US)

(21) Appl. No.: 18/887,957

(22) Filed: Sep. 17, 2024

Related U.S. Application Data
(63) Continuation of application No. PCT/US2023/015369, filed on Mar. 16, 2023.
(60) Provisional application No. 63/320,905, filed on Mar. 17, 2022.

(51) Int. Cl. G06N 5/01

(52) U.S. Cl. CPC G06N 5/01

(57) ABSTRACT

Methods, systems, and apparatus, including computer programs encoded on computer storage media, for selecting, from a set of actions, actions to be performed by an agent interacting with an environment to cause the agent to perform a task. One of the methods includes receiving a current observation characterizing a current environment state of the environment, selecting an action to be performed by the agent in response to the current observation by performing multiple iterations of outer look ahead search, wherein performing the multiple iterations of outer look ahead search comprises, in each outer look ahead search iteration: determining a proper subset of the possible future states of the environment; determining that one or more inner look ahead search commencement criteria are satisfied; and in response, performing an inner look ahead search of the proper subset of the possible future states of the environment.

### CROSS-REFERENCE TO RELATED APPLICATIONS

This application is a continuation of PCT Application No. PCT/US2023/015369, filed on Mar. 16, 2023, which claims priority to U.S. Provisional Patent Application No. 63/320,905, filed on Mar. 17, 2022, and the disclosure of these applications are incorporated herein by reference in their entirety.

### BACKGROUND

This specification relates to selecting actions to be performed by an agent.

For example, the agent can be an agent controlled by a reinforcement learning system. Reinforcement learning agents interact with an environment by receiving an observation that characterizes the current state of the environment, and in response, performing an action. Once the action is performed, the agent receives feedback, referred to as a reward, typically a numeric value, that is dependent on the effect of the performance of the action on the environment, and that can be used to update a model that determines what actions the agent will perform.

Some reinforcement learning systems use neural networks to select the action to be performed by the agent in response to receiving any given observation.

### SUMMARY

This specification describes a system that controls an agent interacting with an environment by, at each of multiple time steps, processing data characterizing the current state of the environment at the time step, i.e., an “observation”, to select an action to be performed by the agent. At each time step, the state of the environment at the time step depends on the state of the environment at the previous time step and the action performed by the agent at the previous time step.

Generally, the system receives the current observation and performs multiple iterations of outer look ahead search. Within each outer look ahead search iteration, the system first determines a proper subset of the possible future states of the environment that is to be explored, and then performs an inner look ahead search of the proper subset of the possible future states of the environment. The system then selects the action to be performed in response to the current observation based on the results of the multiple iterations of outer look ahead search.

Particular embodiments of the subject matter described in this specification can be implemented so as to realize one or more of the following advantages. Actions to be performed by an agent interacting with an environment to perform a complex task that has a very large state space can be effectively selected. In other words, the actions can be effectively selected to maximize the likelihood that a desired result, e.g., performance of a learned task, will be achieved. In particular, actions can be effectively selected when the environment has a state tree that is too large to be searched even when techniques such as alpha-beta pruning or neural network output-guided Monte Carlo search methods are used. By incorporating machine learning to determine which particular subsets of different states of the large state tree to explore, the described techniques reduce the amount of computational resources, time, or both consumed by the search process while still maintain effective performance because exhaustively searching through the state tree is no longer required. Instead, only a relatively small number of states of the environment need to be evaluated during each search iteration. The can allow the system to control the agent to achieve comparable performance with less compute and memory requirements, as well as with reduced runtime latency, than might be needed by previous agent control systems.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example agent control system.

FIG. 2 is a flow diagram of an example process for selecting actions to be performed by an agent interacting with an environment.

FIG. 3 is a flow diagram of sub-steps of one of the steps of the process of FIG. 2.

FIG. 4 is an illustration of an illustrative state tree from an example process for determining a proper subset of the possible future states.

FIG. 5 is a flow diagram of an example process for solving a search problem by searching through a search space that includes a plurality of candidate solutions.

Like reference numbers and designations in the various drawings indicate like elements.

### DETAILED DESCRIPTION

This specification describes a system that controls an agent interacting with an environment by, at each of multiple time steps, processing data characterizing the current state of the environment at the time step, i.e., an “observation”, to select an action to be performed by the agent.

At each time step, the state of the environment at the time step may depend on the state of the environment at the previous time step and the response of the environment to the action performed by the agent at the previous time step.

In some implementations, the environment is a real-world environment and the agent is a mechanical agent interacting with the real-world environment, e.g., a robot or an autonomous or semi-autonomous land, air, or sea vehicle navigating through the environment.

In these implementations, the observations may include, e.g., image data, object position data, or sensor data, or a combination of them, captured as the agent interacts with the environment, for example sensor data from an image, distance, or position sensor or from an actuator.

For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot.

In the case of a robot or other mechanical agent or vehicle, the observations may similarly include one or more of the position, linear or angular velocity, force, torque or acceleration, and global or relative pose of one or more parts of the agent or vehicle. The observations may be defined in 1, 2 or 3 dimensions, and may be absolute or relative observations.

The observations may also include, for example, sensed electronic signals, e.g., motor current or a temperature signals; or image or video data, for example, from a camera or a ranging sensor, e.g., a LIDAR (Light Detection and Ranging) sensor, e.g., data from sensors of the agent or data from sensors that are located separately from the agent in the environment.

In these implementations, the actions may be control inputs to control the robot, e.g., torques for the joints of the robot or higher-level control commands, or to control the autonomous or semi-autonomous land, air, sea vehicle, e.g., torques to the control surface or other control elements of the vehicle or higher-level control commands.

The actions can include, for example, position, velocity, force, torque, or acceleration control signals for one or more joints of a robot or parts of another mechanical agent. Action signals may additionally or alternatively include electronic control data, e.g., motor control data, or more generally data for controlling one or more electronic devices within the environment the control of which has an effect on the observed state of the environment. For example, in the case of an autonomous or semi-autonomous land or air or sea vehicle, the actions may include actions to control navigation, e.g. steering, and movement, e.g., braking or acceleration of the vehicle.

In some other applications the agent may control actions in a real-world environment. The environment may include items of equipment. For example, the agent may control actions in a data center, in a power or water distribution system, in a manufacturing plant or service facility, or in an infrastructure facility, e.g., road, airport, railway station, and so on. The observations may relate to operation of the plant or facility. For example the observations may include observations of power or water usage by equipment, or observations of power generation or distribution control, or observations of usage of a resource or of waste production. The actions may include actions controlling or imposing operating conditions on items of equipment of the plant or facility, or actions that result in changes to settings in the operation of the plant or facility e.g., to adjust, turn on, or turn off components of the plant or facility.

In the case of an electronic agent, the observations may include data from one or more sensors monitoring part of a plant or service facility, e.g., current, voltage, power, temperature or other sensors; the observations may also include electronic signals representing the functioning of electronic or mechanical items of equipment. For example, the real-world environment may be a manufacturing plant or service facility, the observations may relate to operation of the plant or facility, for example, or to resource usage e.g., power consumption, and the agent may control actions or operations in the plant or facility to reduce resource usage, for example. In some other implementations, the real-world environment may be a renewable energy plant, the observations may relate to operation of the plant, for example to maximize present or future planned electrical power generation, and the agent may control actions or operations in the plant to achieve this.

For example, the environment may be the real-world environment of a service facility including a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, air flow control or air conditioning equipment. The task may include a task to control, e.g. minimize, use of a resource, such as a task to control electrical power consumption, or water consumption. The agent may include an electronic agent configured to control operation of the items of equipment, or to control operation of the ancillary, e.g. environmental, control equipment.

In general, the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general, the observations of a state of the environment may include any electronic signals representing the functioning of the facility or of equipment in the facility. For example, a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions, e.g., current, voltage, power or energy; a temperature of the facility; fluid flow, temperature or pressure within the facility or within a cooling system of the facility; or a physical facility configuration, e.g., whether or not a vent is open.

As another example, the environment may be the real-world environment of a power generation facility e.g., a renewable power generation facility such as a solar farm or wind farm. The task may include a control task to control power generated by the facility, e.g., to control the delivery of electrical power to a power distribution grid to meet demand or to reduce the risk of a mismatch between elements of the grid or for some other reason, or to maximize power generated by the facility. The agent may include an electronic agent configured to control the generation of electrical power by the facility, or the coupling of generated electrical power into the grid. The actions may include actions to control an electrical or mechanical configuration of an electrical power generator, e.g., the electrical or mechanical configuration of one or more renewable power generating elements, for example, to control a configuration of a wind turbine or of a solar panel or panels or mirror, or the electrical or mechanical configuration of a rotating electrical power generator. Mechanical control actions may, for example, include actions that control the conversion of an energy input to an electrical energy output, e.g., an efficiency of the conversion or a degree of coupling of the energy input to the electrical energy output. Electrical control actions may, for example, include actions that control one or more of a voltage, current, frequency or phase of electrical power generated.

In some other implementations, the environment is a real-world environment and the agent is a computer system that generates outputs for presentation to a user.

For example, the environment may be a patient diagnosis environment such that each state is a respective patient state of a patient, i.e., as reflected by health data characterizing the health of the patient, and the agent may be a computer system programmed to suggest treatment for the patient. In this example, the actions in the set of actions are possible medical treatments for the patient and the objectives can include one or more of maintaining a current health of the patient, improving the current health of the patient, minimizing medical expenses for the patient, and so on.

Entirely different from real-world environments of the kind described above are simulated environments, some examples of which will now be described.

In some implementations, the environment is a simulated environment and the agent is implemented as one or more computer programs interacting with the simulated environment. For example, the simulated environment may be a virtual environment in which a user competes against a computerized agent to accomplish a goal and the agent is the computerized agent. In this example, the actions in the set of actions are possible actions that can be performed by the computerized agent and the objective may be, e.g., to win the competition against the user.

As another example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle.

As another example, the simulated environment may be a chemical synthesis or protein folding environment such that each state is a respective state of a protein chain or of one or more intermediates or precursor chemicals and the agent is a computer system for determining how to effect a folding of the protein chain or synthesize the chemical. In this example, the actions are possible simulated folding actions that effect the folding of the protein chain or simulated actions for assembling precursor chemicals or intermediates and the result to be achieved may include, e.g., folding the protein so that the protein is stable and so that it achieves a particular biological function or providing a valid synthetic route for the chemical. As another example, the agent may be a software program that performs or controls the protein folding actions or chemical synthesis steps selected by the system automatically without human interaction. The observations may include direct or indirect observations of a state of the protein or chemical intermediates or precursors. Some observations may be derived from simulation.

In the case of a simulated environment, the observations include simulated versions of one or more of the previously described observations or types of observations and the actions include simulated versions of one or more of the previously described actions or types of actions.

Optionally, in any of the above implementations, the observation at any given time step may include data from a previous time step that characterizes the environment, e.g., the action performed at the previous time step, the reward received at the previous time step, and so on. The reward, which may be issued by the environment to the agent, is typically specified by a scalar numerical value and characterizes, e.g., a progress of the agent towards completing an assigned task. Accordingly, the system can be used to select actions to be performed by the agent in an effort to maximize a reward function that measures, e.g., a time-adjusted sum of total rewards.

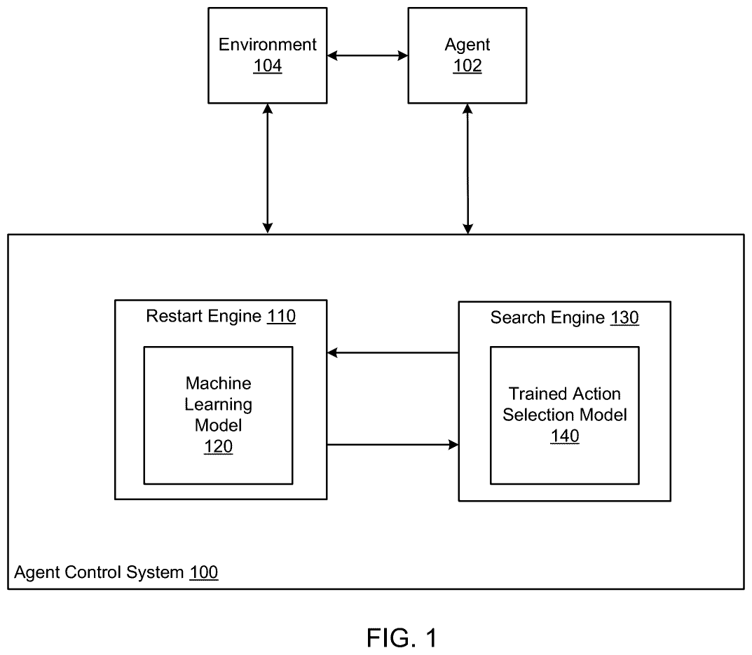

FIG. 1 shows an example agent control system 100. The agent control system 100 is an example of a system implemented as computer programs on one or more computers in one or more locations in which the systems, components, and techniques described below are implemented.

The agent control system 100 selects actions to be performed by an agent 102 interacting with an environment 104 to perform a task, achieve an objective, or both. That is, the agent control system 100 receives observations, with each observation being data characterizing a respective state of the environment 104, and, in response to each received observation, selects an action from a set of actions to be performed by the agent 102 in response to the observation.

Once the agent control system 100 selects an action to be performed by the agent 102, the agent control system 100 causes the agent 102 to perform the selected action, e.g., by instructing the agent to perform the action or passing a control signal to a control system for the agent. Generally, the agent 102 performing the selected action results in the environment 104 transitioning into a different state.

The observations characterize the state of the environment in a manner that is appropriate for the context of use for the agent control system 100.

For example, when the agent control system 100 is a control system for a mechanical agent interacting with the real-world environment, the observations may be or include images captured by sensors of the mechanical agent as it interacts with the real-world environment and, optionally, other sensor data captured by the sensors of the agent.

As another example, when the environment 104 is a patient diagnosis environment, the observations may be or include data from an electronic medical record of a current patient.

As another example, when the environment 104 is a protein folding environment, the observations may be or include images of the current configuration of a protein chain, a vector characterizing the composition of the protein chain, or both.

In particular, the agent control system 100 selects the actions by using a restart engine 110 and a search engine 130 to execute a planning process every time an action needs to be selected. Each planning process involves performing multiple iterations of outer look ahead search to traverse a portion of a space of possible future states of the environment starting from a current state of the environment. The current state of the environment is the state of the environment 104 that is characterized by a current observation received by the agent control system 100.

To assist in each planning process, some implementations of the agent control system 100 maintain data representing the possible states of the environment 104. Some implementations of the agent control system 100 also have access to a simulator of the environment which provides a simulated version of the environment 104 that simulates the effects of the performed actions by the agent 102 on the environment 104, and can use such a simulator to determine which state the environment 104 will transition into as a result of a given action being performed in a given state.

Put another way, each planning process, which includes traversing multiple future states of the environment, assuming that the agent performs certain actions, reflects a different approach to performing the same particular task or achieving the same particular objective. The agent control system 100 thus may also be viewed as an optimization system that solves a problem of finding a final solution to the technical problem of agent control, as a result of searching through a search space that includes multiple candidate solutions, where each candidate solution is represented by a succession of multiple environment states. Generally, the longer the succession of environment states is, the more complete the candidate solution may be in terms of solving the technical problem.

The restart engine 110 is a machine learning subsystem of the control system 100 that includes a machine learning model 120. At each iteration of outer look ahead search, the restart engine 110 uses the machine learning model 120 to determine a proper subset of the possible future states of the environment 104 starting from the current state characterized by the current observation.

The machine learning model 120 is configured to receive an input that includes data specifying a current subset of possible future states of the environment that have already been visited in previous outer look ahead search iterations, and to process the input to generate an output that includes data specifying one or more unvisited, possible future states of the environment. Each unvisited, possible future state can be a subsequent state of a terminal state of any of the previous outer look ahead search iterations at which the previous outer look ahead search iteration terminated.

The machine learning model 120 can have any appropriate architecture that allows the model 120 to map a current subset of possible future states that have already been visited to one or more unvisited, possible future states of the environment. For example, the machine learning model 120 can be a neural network, a support vector machine (SVM) model, a decision forest model, including gradient boosting decision forest models, or as any other type of trainable machine learning model. The machine learning model 120 can be trained on data generated as a result of the previous interactions of the agent 102, or another agent, with the environment 104, or another instance of the environment, when performing tasks that are similar to the assigned task.

The agent control system 100 then updates a proper subset of the possible future states of the environment 104, which has been determined as of the previous outer look ahead search iterations, to include the one or more unvisited, possible future states as determined by the restart engine 110 in the current iteration of outer look ahead search. Collectively, the proper subset of the possible future states represents a smaller, and sometimes much smaller and thus much more focused, portion of the entire space of the possible future states of the environment that will need to be traversed in the current outer look ahead search iteration.

Then, within the current iteration of outer look ahead search, the search engine 130 performs an inner look ahead search to search through the proper subset of the possible future states of the environment 104. The search engine 130 can generally use any search-based optimization algorithm to search through the proper subset of the possible future states to determine which action from a set of possible actions is to be performed by the agent, i.e., as a result of applying the optimization algorithm to the proper subset of the possible future states. The search-based optimization algorithm can be a heuristic search algorithm, e.g., a depth or breadth first search algorithm, a greedy search algorithm, or an A* search algorithm, to name just a few examples.

In some implementations, the search engine 130 can perform the inner look ahead search by performing a tree search guided by the outputs of a trained action selection model 140, where the search-based optimization algorithm can for example include look ahead tree search with alpha-beta pruning, or Monte Carlo tree search.

In some implementations, the action selection model 140 is a neural network model that is configured to receive a network input including an observation and to process the network input in accordance with parameters of the action selection model to generate a network output. The observation can be an observation, e.g., a simulated one that is generated by the simulator, that characterizes a possible future state in the proper subset of the possible future states of the environment 104 that have been determined by the restart engine 110. The network output includes an action selection output which defines an action selection policy for selecting an action to be performed by the agent in response to the observation.

Example configurations of such an action selection model 140, as well as how inner look ahead searches can be performed with the guidance of the action selection outputs, are described in U.S. Patent No. U.S. Pat. No. 11,449,750B2 and U.S. Pat. No. 10,867,242B2, which are incorporated herein by reference. Performing the inner look ahead search with the guidance of the action selection outputs to select an action for the agent in these examples means that, instead of directly using the action selection output generated by the action selection model 140 to select an action, the system performs a guided look ahead search guided by the action selection model 140 and then selects an action based on the results of the guided look ahead search.

In this way, at each iteration of the outer look ahead search, the agent control system 100 uses the restart engine 110 to determine a proper subset of the possible future states of the environment 104 from all of the possible future states of the environment 104 and only traverses the states in the proper subset using the search engine 130. By doing so the agent control system 100 reduces the number of possible future states of the environment that need to be traversed by using the search engine 130 in the inner look ahead search during each iteration of outer look ahead search, while still allowing for accurate control of the agent 102, i.e., for the selection of a high quality action in response to any given observation.

The number of states in the proper subset is generally much smaller than the total number of states in the space of all possible states of the environment 104. For example, even when the space of possible states includes on the order of 2¹⁰⁰ possible states, the system can still accurately control the agent with only 2²⁰ states being included in the proper subset, e.g., with 2¹⁰ actions being added to the proper subset during each outer look ahead search iteration.

This can allow the agent control system 100 to control the agent 102 with reduced latency and while consuming fewer computational resources than existing approaches that always attempt to search through the entire space of possible states of the environment 104 when selecting actions in response to observations.

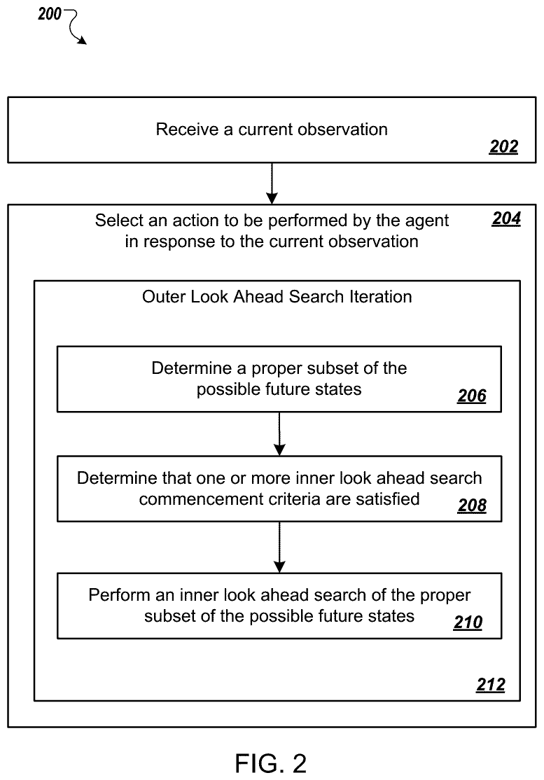

FIG. 2 is a flow diagram of an example process 200 for selecting actions to be performed by an agent interacting with an environment. For convenience, the process 200 will be described as being performed by a system of one or more computers located in one or more locations. For example, an agent control system, e.g., the agent control system 100 of FIG. 1, appropriately programmed in accordance with this specification, can perform the process 200.

The system receives a current observation that characterizes a current environment state of the environment (step 202). In some implementations, the observation can include visual data, e.g., an image or a video frame, while in other implementations, the observation can be multimodal observations that additionally incorporate information about text, e.g., natural language instructions, rewards, or other sensory inputs including touch, smell, sound, or temperature.

The system selects an action to be performed by the agent in response to the current observation (step 204). To facilitate this selection, the system performs multiple iterations 212 of outer look ahead search to generate an evaluation of possible future states of the environment that start from the current environment state, i.e., that are subsequent states of the current environment state in the environment. Each outer look ahead search iteration 212 includes steps 206-210, and thus performing the multiple iterations 212 of outer look ahead search involves repeating steps 206-210 multiple times.

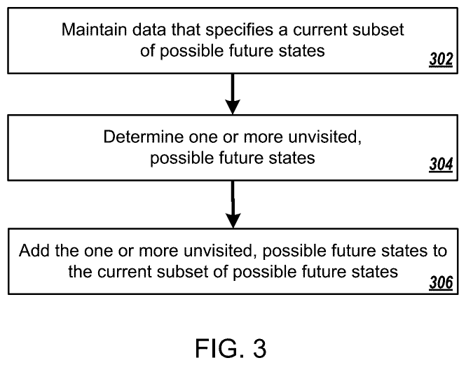

The system determines a proper subset of the possible future states of the environment that is to be explored (step 206). At each outer look ahead search iteration, the system can determine a proper subset of the possible future states of the environment by using a machine learning model to identify unvisited, possible future state of the environment to add to the current subset. Step 206 is explained in more detail with reference to FIG. 3, which shows sub-steps 302-306 of the step 206.

The system maintains data that specifies a current subset of possible future states of the environment that have already been visited in previous outer look ahead search iterations (step 302).

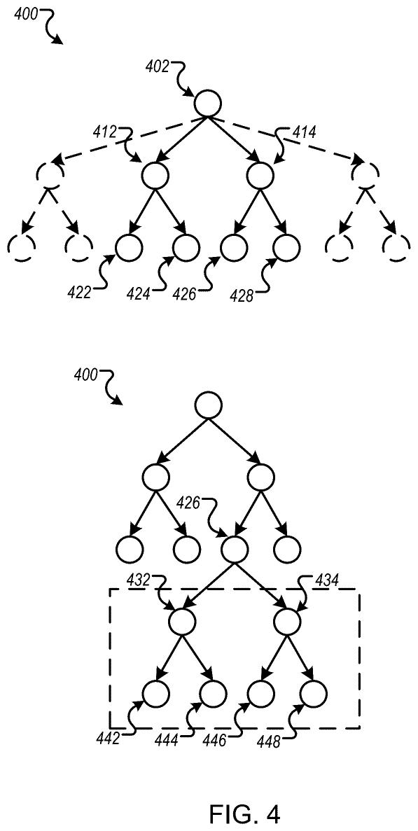

FIG. 4 is an illustration of an illustrative state tree from an example process for determining a proper subset of the possible future states. The system maintains data representing a state tree 400 of the environment. The state tree 400 includes nodes that represent states of the environment and directed edges that connect nodes in the tree. An outgoing edge from a first node to a second node in the tree represents an action that, once performed in response to an observation characterizing the first state, will result in the environment transitioning into the second state. While the data is logically described as a tree in the example of FIG. 4, the data can be represented by any of a variety of convenient physical data structures, e.g., as multiple triples or as an adjacency list.

In the state tree 400, nodes 402, 412, 414, 422, 424, 426, and 428 constitute the current subset of possible future states of the environment that have already been visited in previous outer look ahead search iterations. Among these nodes, the system can identify a current node in the state tree, e.g., root node 402, that represents the current environment state characterized by the current observation. The system can also identify nodes, e.g., leaf nodes 422, 424, 426, and 428, that represent the terminal states of the previous outer look ahead search iterations at which the previous outer look ahead search iterations terminated. In a state tree, e.g., the state tree 400 generated as of the most recent outer look ahead search iteration, a leaf node is a node that has no child nodes, i.e., is not connected to any other nodes by an outgoing edge. Hence, a leaf node may also be referred to as an “unexpanded” node in the state tree representing the environment.

The system determines one or more unvisited, possible future states beginning from the terminal states represented by the identified leaf nodes (step 304). That is, the system expands the leaf nodes, and in particular does so by using the machine learning model, optionally together with the simulator of the environment.

When used by the system, the machine learning model is configured to receive an input that includes data specifying the current subset of possible future states of the environment that have already been visited in previous outer look ahead search iterations, and to process the input to generate an output that includes data specifying one or more unvisited, possible future states of the environment. Each unvisited, possible future state can be a subsequent state of a terminal state of any of the previous outer look ahead search iterations at which the previous outer look ahead search iteration terminated.

In some implementations, the machine learning model can generate these unvisited, possible future states over multiple time steps, i.e., can generate these unvisited, possible future states one after another in a sequential, e.g., autoregressive, manner.

In some implementations, these unvisited, possible future states are generated deterministically, e.g., by an output of the machine learning model. In other implementations, these unvisited, possible future states are generated stochastically, e.g., where the output of the machine learning model parameterizes a distribution, e.g., a score distribution among the space of possible future states of the environment, from which the one or more unvisited, possible future states can be sampled.

The one or more unvisited, possible future states generated in this way will include future states in the space of environment that the environment may transition into beginning from a terminal state of any of the previous outer look ahead search iterations, as a result of the agent performing one or more valid actions selected from the set of actions that can be performed by the agent.

In the example of FIG. 4, the system uses the machine learning model to process an input that includes data describing nodes 402, 412, 414, 422, 424, 426, and 428, and to process the input to generate an output that includes data describing nodes 432, 434, 442, 444, 446, and 448, each of which represent an unvisited, possible future state of the environment. In this example, node 432 represents an immediate future state that the environment will transition into in response to the agent performing a valid action in the set of actions when the environment is in the terminal state represented by node 426, and node 442 (or node 444) represents a next immediate future state that the environment will transition into in response to the agent performing a valid action in the set of actions when the environment is in the state represented by node 432.

Instead of or in addition to those unvisited, possible future states of the environment, in some cases, the output of the machine learning model may include data specifying one or more already visited states of the environment. For example, as illustrated in FIG. 4, the output of the machine learning model may instead or additionally include data describing node 402, 412, or 414.

The system adds the one or more unvisited, possible future states to the current subset of possible future states of the environment that have already been visited in the previous outer look ahead search iterations (step 306). That is, the system updates the current subset of possible future states of the environment specified in the maintained data to also include the one or more unvisited, possible future states determined by using the machine learning model. In the example of FIG. 4, the unvisited, possible future states represented by nodes 432, 434, 442, 444, 446, and 448, will be added to the current subset of the possible future states of the environment that is to be explored. In cases where only already visited states of the environment were determined by using the machine learning model, no extra environment state will need to be added the current subset of possible future states of the environment specified in the maintained data.

When the state space is large, determining the proper subset of the possible future states of the environment by using the machine learning model in this way can take a long processing time, and can also be computationally intensive and consume a significant amount of computational resources. Thus, whenever one or more inner look ahead search commencement criteria are satisfied, the system will determine that an inner look ahead search should begin and correspondingly halt the ongoing determination of the proper subset of the possible future states at step 206.

The system determines that one or more inner look ahead search commencement criteria are satisfied (step 208). As mentioned above, such inner look ahead search commencement criterion specifies when process 200 should advance from step 206 to step 210.

For example, the commencement criteria can include a maximum number criterion, which specifies that process 200 should advance from step 206 to step 210 whenever a predetermined number of different states of the environment have been generated by using the machine learning model.

As another example, the commencement criteria can include a sufficiency criterion, which specifies that process 200 should advance from step 206 to step 210 whenever the proper subset of the possible future states of the environment that is to be explored is sufficient in terms of generating an evaluation of the possible future states of the environment starting from the current environment state. To determine the sufficiency in this example, the system can evaluate the proper subset of the possible future states of the environment by computing a stopping function to generate a binary classification result that specifies whether the proper subset of the possible future states of the environment is sufficient. For example, the stopping function can be implemented as a trained classifier model, or can be realized deterministically as a parametric equation.

As another example, the commencement criteria can include a timeout criterion, which specifies that process 200 should advance from step 206 to step 210 whenever a time that has been spent on determining the unvisited, possible future states by using the machine learning model exceeds a predetermined time length, e.g., 1 s, 5 s, 10 s, or the like.

In response, the system performs an inner look ahead search of the proper subset of the possible future states of the environment (step 210). In some implementations, the inner look ahead search implements a heuristic search algorithm, e.g., a depth or breadth first search algorithm, a greedy search algorithm, or an A* search algorithm. In some other implementations, the inner look ahead search is a Monte Carlo tree search guided by the action selection model in accordance with values of the network parameters, such that the Monte Carlo tree search is dependent upon the action selection outputs from the action selection model.

In particular, the system performs the inner look ahead search to traverse only the proper subset of the possible future states of the environment, i.e. rather than the entire space of the possible future states of the environment, starting from the current state characterized by the current observation until one or more inner look ahead search termination criteria are satisfied.

For example, the system can traverse a state tree starting from a root node of the state tree representing the current environment state, through the nodes that represent the proper subset of the possible future states of the environment, and until reaching a leaf node in the state tree.

After having performed the multiple iterations of outer look ahead search, the system can proceed to select the action to be performed by the agent in response to the current observation using statistics generated during the multiple iterations of outer look ahead search for the root node of the state tree that represents the current observation.

Different statistics may be compiled when different variations of the heuristic search algorithm or the Monte Carlo tree search are used to perform the inner look ahead search of the proper subset of the possible future states of the environment during each iteration of the outer look ahead search. For example, the statistics may include, for each outgoing edge connected to the root node that represents a corresponding action that was performed by the agent in response to the current observation, a respective action score for the action represented by the edge. Each action score specifies a likelihood that the agent will complete the task if the action is performed. In this example, the system can select the action that has a highest action score as the action to be performed by the agent in response to the current observation.

As another example, the statistics may include, for each outgoing edge connected to the root node that represents a corresponding action that was performed by the agent in response to the current observation, a respective visit count for the action represented by the edge. Each visit count represents a number of times that the action has been considered by the agent as an action that might be performed in response to the current observation. In this example, the system can select the action that has a highest visit count as the action to be performed by the agent in response to the current observation.

In either example, the system can maintain edge data for each edge in the state tree that includes (i) an action score for the action represented by the edge, (ii) a visit count for the action represented by the edge, or both together with the data that representing the state trec. The system can update the maintained data representing the state tree and the edge data for the edges in the state tree from interactions of the agent with the simulated version of the environment using the search engine.

The system can repeat the process 200 for each observation received during an episode of interaction of the agent with the environment. An episode refers to a sequence of time steps over which the agent interacts with the environment. An episode can terminate, e.g., when the agent has interacted with the environment for a predefined number of time steps, or when the agent completes the task.

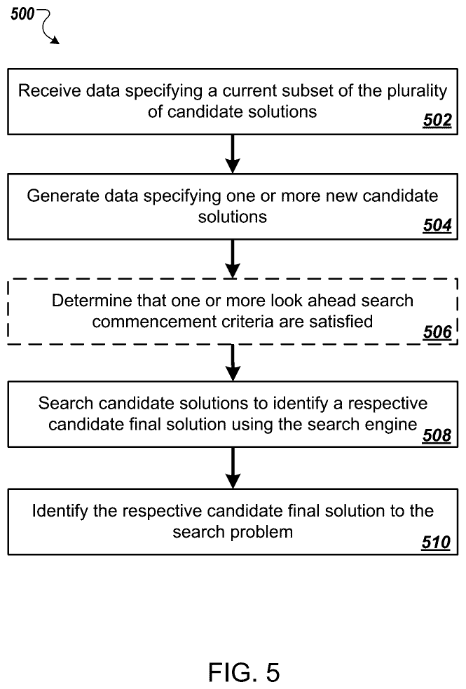

FIG. 5 is a flow diagram of an example process 500 for solving a problem by searching through a search space that includes a plurality of candidate solutions. For convenience, the process 500 will be described as being performed by a system of one or more computers located in one or more locations. For example, an agent control system, e.g., the agent control system 100 of FIG. 1, appropriately programmed in accordance with this specification, can perform the process 500.

Each candidate solution may be viewed as a different approach for solving the problem. In various implementations, the search space of the plurality of candidate solutions may be provided or otherwise defined by a user or randomly generated by the system, for example. The process 500 finds solutions by iteratively identifying a respective proper subset of the plurality of candidate solutions and then analyzing the candidate solutions in the respective proper subset, until reaching a satisfactory solution. For example, the problem can be a problem in the field of engineering, biology, or robotics that is defined in the format of a combinatorial optimization problem, e.g., an assignment problem, which involves assigning a group of workers to perform a set of tasks, a packing problem, which involves finding a way to pack a set of items of given sizes into containers with fixed dimensions, a scheduling program, e.g., factory job scheduling problem, which involves assigning people and resources to tasks at specific times, or a network flow problem, which involves transporting goods or material across a network, such as a railway system.

In brief, the system uses a machine learning subsystem to repeatedly perform steps 502 and 504 to identify the respective proper subsets of the plurality of candidate solutions over multiple outer search iterations. For the respective proper subset identified during each outer search iteration, the system then uses a search engine to perform steps 508 and 510 to search the candidate solutions in the proper subset to identify a respective candidate final solution.

The system receives, at the machine learning subsystem, a machine learning subsystem input that includes data specifying a current subset of the plurality of candidate solutions that have already been searched in previous outer search iterations (step 502).

The system processes the machine learning subsystem input using the machine learning subsystem configured to generate a machine learning subsystem output that includes data specifying one or more new candidate solutions that are to be searched in the current outer search iteration (step 504). In some implementations, the machine learning subsystem is configured to generate at most a predetermined, e.g., user-specified, number of new candidate solutions in each current outer search iteration.

The system maintains data specifying the current subset of the plurality of candidate solutions that have already been searched in the previous outer search iterations. After step 504, the system updates the current subset of the plurality of candidate solutions by adding the one or more new candidate solutions to the current subset.

The system searches candidate solutions to identify a respective candidate final solution by using a search engine (step 508). In particular, the system does this by using the search engine to search the updated current subset of the plurality of candidate solutions that includes the one or more new candidate solutions determined at step 504 in each current outer search iteration.

In some implementations, searching the candidate solutions includes first determining that one or more look ahead search commencement criteria are satisfied (optional step 506) and subsequently proceeding to perform step 508. For example, determining that the one or more look ahead search commencement criteria are satisfied can include determining that the updated current subset of the candidate solutions are sufficient in terms of generating an evaluation result that is representative of all of the plurality of candidate solutions in the search space. In this example, the system can determine whether the updated current subset of the candidate solutions are sufficient based on evaluating, by computing a stopping function, the respective candidate final solution that has been identified from the updated current subset of the candidate solutions, to generate a binary classification result that specifies whether the respective candidate final solution is a valid solution to the problem. In other words, the updated current subset of the candidate solutions would be considered sufficient by the system if a valid solution can be obtained from the updated current subset.

As another example, determining that the one or more look ahead search commencement criteria are satisfied can include determining that a time spent on processing the machine learning system input to generate the machine learning subsystem output exceeds a predetermined time length.

In each current outer search iteration, the system identifies the respective candidate final solution to the problem (step 508). To identify the candidate final solution, the system performs a look ahead search of possible continuing solutions that start from at least the one or more new candidate solutions specified by the machine learning subsystem output that have been determined at step 504, until one or more look ahead search termination criteria are satisfied.

For example, the search problem can be represented by a search tree, and the look ahead search can be a look ahead tree search, e.g., a Monte Carlo tree search. In this example, a root node of the search tree for the look ahead tree search represents an initial, partial solution to the problem, and child nodes on a path from the root node each represent a candidate continuation of the initial, partial solution. The look ahead tree search will then include traversing the paths that connect the particular child nodes of the search tree that each represent one of the new candidate solution specified by the data included in the machine learning subsystem output, until reaching a leaf node of the search tree.

The system then selects, from the plurality of candidate solutions, and as the respective candidate final solution, a selected candidate solution as a result of performing the look ahead search. In some implementations, the system generates an evaluation result of the one or more new candidate solutions by evaluating the one or more new candidate solutions determined at step 504 using the statistics compiled from the look ahead search with respect to solving the problem, e.g., according to an objective function associated with the problem, and then using the evaluation results to select the selected candidate solution. For example, the evaluation result can include a likelihood of the new candidate solution being a mathematically optimal solution to the problem.

After performing the multiple outer search iterations, the system proceeds to use the search engine to identify a final solution to the problem from the respective candidate final solutions generated in the multiple outer search iterations, for example by identifying the candidate final solution that has a highest likelihood of the solution being an optimal solution to the problem.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a method for selecting, from a set of actions, actions to be performed by an agent interacting with an environment to cause the agent to perform a task, the method comprising:
receiving a current observation characterizing a current environment state of the environment;
selecting an action to be performed by the agent in response to the current observation by performing multiple iterations of outer look ahead search to generate an evaluation of possible future states of the environment starting from the current environment state, wherein performing the multiple iterations of outer look ahead search comprises, in each outer look ahead search iteration:
   determining a proper subset of the possible future states of the environment that is to be explored;
   determining that one or more inner look ahead search commencement criteria are satisfied; and
   in response, performing an inner look ahead search of the proper subset of the possible future states of the environment until one or more inner look ahead search termination criteria are satisfied.

Embodiment 2 is the method of claim 1, wherein determining the proper subset of the possible future states comprises:
maintaining data that specifies a current subset of possible future states of the environment that have already been visited in previous outer look ahead search iterations;
determining one or more unvisited, possible future states, beginning from one or more terminal states of any of the previous outer look ahead search iterations at which the previous outer look ahead search iteration terminated; and
adding the one or more unvisited, possible future states to the current subset of possible future states of the environment that have already been visited in the previous outer look ahead search iterations.

Embodiment 3 is the method of embodiment 2, wherein determining the one or more unvisited, possible future states comprise selecting at most a predetermined number of different states of the environment.

Embodiment 4 is the method of any one of embodiments 2-3, wherein the one or more unvisited, possible future states comprise future states that the environment will transition into from a terminal state of any of the previous outer look ahead search iterations in response to the agent performing a valid action in the set of actions when the environment is in the terminal state.

Embodiment 5 is the method of any one of embodiments 1-4, wherein determining that the one or more inner look ahead search commencement criteria are satisfied comprises:

determining that the proper subset of the possible future states of the environment that is to be explored is sufficient in terms of generating the evaluation of the possible future states of the environment starting from the current environment state.

Embodiment 6 is the method of embodiment 5, wherein determining that the proper subset of the possible future states of the environment that is to be explored is sufficient comprises:

evaluating, by computing a stopping function, the proper subset of the possible future states of the environment, to generate a binary classification result that specifies whether the proper subset of the possible future states of the environment is sufficient.

Embodiment 7 is the method of any one of embodiments 1-4, wherein determining that the one or more inner look ahead search commencement criteria are satisfied comprises:

determining that a time spent on determining the one or more unvisited, possible future states exceed a predetermined time length.

Embodiment 8 is the method of any one of embodiments 1-7, wherein performing the inner look ahead search of the proper subset of the possible future states of the environment until the one or more termination criteria are satisfied comprises:

traversing a state tree starting from a root node of the state tree representing the current environment state until reaching a leaf node in the state tree.

Embodiment 9 is the method of embodiment 8, wherein selecting the action to be performed by the agent comprises:

selecting the action to be performed by the agent in response to the current observation using statistics generated during the multiple iterations of outer look ahead search for the root node of the state tree that represents the current observation.

Embodiment 10 is the method of embodiment 9, wherein the statistics comprise, for each outgoing edge connected to the root node that represents a corresponding action that was performed by the agent in response to the current observation, a respective action score for the action represented by the edge, which action score specifies a likelihood that the agent will complete the task if the action is performed; and

wherein selecting the action to be performed by the agent comprises selecting the action that has a highest action score.

Embodiment 11 is the method of embodiment 9, wherein the statistics comprise, for each outgoing edge connected to the root node that represents a corresponding action that was considered by the agent as an action that might be performed in response to the current observation, a respective visit count for the action represented by the edge, which visit count represents a number of times that the action has been considered by the agent as an action that might be performed in response to the current observation, and

wherein selecting the action to be performed by the agent comprises selecting the action that has a highest visit count.

Embodiment 12 is the method of any one of embodiments 1-11, wherein performing the inner look ahead search comprises performing a Monte Carlo tree search.

Embodiment 13 is the method of embodiment 12, wherein performing the Monte Carlo tree search comprises performing the Monte Carlo tree search guided by outputs of a neural network, wherein the neural network is configured to receive an input observation characterizing a state of the environment and to process the input observation in accordance with network parameters to generate a network output that specifies an action to be performed by the agent in response to the input observation.

Embodiment 14 is the method of any one of embodiments 1-11, wherein performing the inner look ahead search comprises performing a look ahead tree search with alpha-beta pruning techniques.

Embodiment 15 is the method of any one of embodiments 1-14, wherein the agent is a mechanical agent, the environment is a real-world environment, and the current observation comprises data from one or more sensors configured to sense the real-world environment.

Embodiment 16 is the method of claim 15, wherein the agent comprises a robot or a vehicle.

Embodiment 17 is the method of any one of embodiments 15-16, wherein the agent comprises data processing apparatus configured to process the current observation and to generate control signals that cause the agent to perform the selected action in a real-world environment.

Embodiment 18 is the method of any one of embodiments 1-14, wherein the agent is a computer program, the environment is a real-world environment, and the observation comprises data from one or more sensors configured to sense the real-world environment, and the agent performs the task by providing instructions specifying action in the real-world environment.

Embodiment 19 is a system comprising: one or more computers and one or more storage devices storing instructions that are operable, when executed by the one or more computers, to cause the one or more computers to perform the method of any one of embodiments 1 to 18.

Embodiment 20 is a computer storage medium encoded with a computer program, the program comprising instructions that are operable, when executed by data processing apparatus, to cause the data processing apparatus to perform the method of any one of embodiments 1 to 18.

Embodiment 21 is a computed-implemented system for solving a search problem by searching through a search space comprising a plurality of candidate solutions, wherein the system comprises:
a machine learning subsystem and a search engine, wherein
the machine learning subsystem is configured to identify a proper subset of the plurality of candidate solutions, the machine learning subsystem configured to, in each current outer search iteration of multiple outer search iterations:
   receive a machine learning subsystem input that includes data specifying a current subset of the plurality of candidate solutions that have already been searched in previous outer search iterations;
   process the machine learning subsystem input to generate a machine learning subsystem output that includes data specifying one or more new candidate solutions that are to be searched in the current outer search iteration; and
   search candidate solutions to identify a respective candidate final solution using the search engine, wherein the searched candidate solutions include the one or more new candidate solutions, and wherein
the search engine is configured to, in each current outer search iteration:
   identify the respective candidate final solution to the search problem by performing a look ahead search of possible continuing solutions that start from at least the one or more new candidate solutions specified by the machine learning subsystem output, until one or more look ahead search termination criteria are satisfied, and selecting, from the plurality of candidate solutions, and as the respective candidate final solution, a selected candidate solution as a result of performing the look ahead search.

Embodiment 22 is the system of embodiment 21, wherein the machine learning subsystem is further configured to, in each current outer search iteration:
maintain the data specifying the current subset of the plurality of candidate solutions that have already been searched in the previous outer search iterations, including updating the current subset of the plurality of candidate solutions by adding the one or more new candidate solutions.

Embodiment 23 is the system of any one of embodiments 21-22, wherein selecting the selected candidate solution as the result of performing the look ahead search comprises:
generating an evaluation result of the one or more new candidate solutions by evaluating the one or more new candidate solutions with respect to solving the search problem; and
using the evaluation results to select the selected candidate solution.

Embodiment 24 is the system of embodiment 23, wherein the evaluation result comprises a likelihood of the new candidate solution being a mathematically optimal solution to the search problem.

Embodiment 25 is the system of any one of embodiments 21-24, wherein the search engine is further configured to identify a final solution to the search problem from the respective candidate final solutions generated in the multiple outer search iterations.

Embodiment 26 is the system of any one of embodiments 21-25, wherein the search problem comprises a factory job scheduling problem.

Embodiment 27 is the system of any one of embodiments 21-26, wherein the machine learning subsystem is configured to generate at most a predetermined number of new candidate solutions in each current outer search iteration.

Embodiment 28 is the system of any one of embodiments 21-27, wherein searching the candidate solutions to identify the respective candidate final solution using the search engine comprises determining that one or more look ahead search commencement criteria are satisfied.

Embodiment 29 is the system of embodiment 28, wherein determining that the one or more look ahead search commencement criteria are satisfied comprises:
determining that the updated current subset of the candidate solutions are sufficient in terms of generating an evaluation result of all of the plurality of candidate solutions in the search space, or
determining that a time spent on processing the machine learning system input to generate the machine learning subsystem output exceed a predetermined time length.

Embodiment 30 is the system of embodiment 29, wherein determining that the updated current subset of the candidate solutions are sufficient comprises:
evaluating, by computing a stopping function, the respective candidate final solution that has been identified from the updated current subset of the candidate solutions, to generate a binary classification result that specifies whether the respective candidate final solution is a valid solution to the search problem.

Embodiment 31 is the system of any one of embodiments 21-30, wherein the look ahead search comprises a Monte Carlo tree search.

Embodiment 32 is one or more computer storage media storing instructions that when executed by one or more computers cause the one or more computers to implement the machine learning subsystem and the search engine of any one of embodiments 21-31.

Embodiment 33 is a method comprising the operations that the machine learning subsystem and the search engine of any one of embodiments 21-31 is configured to perform.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system comprising: one or more computers and one or more storage devices storing instructions that are operable, when executed by the one or more computers, to cause the one or more computers to perform a method for selecting, from a set of actions, actions to be performed by an agent interacting with an environment to cause the agent to perform a task, the method comprising:
receiving a current observation characterizing a current environment state of the environment;
selecting an action to be performed by the agent in response to the current observation by performing multiple iterations of outer look ahead search to generate an evaluation of possible future states of the environment starting from the current environment state, wherein performing the multiple iterations of outer look ahead search comprises, in each outer look ahead search iteration:
performing an ongoing determining of a proper subset of the possible future states of the environment that is to be explored
determining that one or more inner look ahead search commencement criteria are satisfied and in response halting the ongoing determining of the proper subset; and
then, performing an inner look ahead search of only the proper subset of the possible future states of the environment, and not any remaining possible future states of the environment that are not in the proper subset, until one or more inner look ahead search termination criteria are satisfied.

2. The system of claim 1, wherein the agent is a mechanical agent, the environment is a real-world environment, and the current observation comprises data from one or more sensors configured to sense the real-world environment.

3. The system of claim 1, wherein the agent is a computer program, the environment is a real-world environment, and the observation comprises data from one or more sensors configured to sense the real-world environment, and the agent performs the task by providing instructions specifying the selected action in the real-world environment.

4. The system of claim 1, wherein determining the proper subset of the possible future states comprises:
maintaining data that specifies a current subset of possible future states of the environment that have already been visited in previous outer look ahead search iterations;
determining one or more unvisited, possible future states, beginning from one or more terminal states of any of the previous outer look ahead search iterations at which the previous outer look ahead search iteration terminated; and
adding the one or more unvisited, possible future states to the current subset of possible future states of the environment that have already been visited in the previous outer look ahead search iterations.

5. The system of claim 4, wherein the one or more unvisited, possible future states comprise future states that the environment will transition into from a terminal state of any of the previous outer look ahead search iterations in response to the agent performing a valid action in the set of actions when the environment is in the terminal state.

6. The system of claim 1, wherein determining that the one or more inner look ahead search commencement criteria are satisfied comprises:
determining that the proper subset of the possible future states of the environment that is to be explored is sufficient in terms of generating the evaluation of the possible future states of the environment starting from the current environment state.

7. The system of claim 6, wherein determining that the proper subset of the possible future states of the environment that is to be explored is sufficient comprises:
evaluating, by computing a stopping function, the proper subset of the possible future states of the environment, to generate a binary classification result that specifies whether the proper subset of the possible future states of the environment is sufficient.

8. The system of claim 1, wherein determining that the one or more inner look ahead search commencement criteria are satisfied comprises:
determining that a time spent on determining the one or more unvisited, possible future states exceed a predetermined time length.

9. The system of claim 1, wherein performing the inner look ahead search of the proper subset of the possible future states of the environment until the one or more inner look ahead search termination criteria are satisfied comprises:
traversing a state tree starting from a root node of the state tree representing the current environment state until reaching a leaf node in the state tree.

10. The system of claim 9, wherein selecting the action to be performed by the agent comprises:
selecting the action to be performed by the agent in response to the current observation using statistics generated during the multiple iterations of outer look ahead search for the root node of the state tree that represents the current observation;
wherein the statistics comprise, for each outgoing edge connected to the root node that represents a corresponding action that was performed by the agent in response to the current observation, a respective action score for the action represented by the edge, which action score specifies a likelihood that the agent will complete the task if the action is performed; and
wherein selecting the action to be performed by the agent comprises selecting the action that has a highest action score.

11. The system of claim 9, wherein selecting the action to be performed by the agent comprises:
selecting the action to be performed by the agent in response to the current observation using statistics generated during the multiple iterations of outer look ahead search for the root node of the state tree that represents the current observation;
wherein the statistics comprise, for each outgoing edge connected to the root node that represents a corresponding action that was considered by the agent as an action that might be performed in response to the current observation, a respective visit count for the action represented by the edge, which visit count represents a number of times that the action has been considered by the agent as an action that might be performed in response to the current observation, and
wherein selecting the action to be performed by the agent comprises selecting the action that has a highest visit count.

12. The system of claim 1, wherein performing the inner look ahead search comprises performing a Monte Carlo tree search guided by outputs of a neural network, wherein the neural network is configured to receive an input observation characterizing a state of the environment and to process the input observation in accordance with network parameters to generate a network output that specifies an action to be performed by the agent in response to the input observation.

13. One or more computer storage media storing instructions that when executed by one or more computers cause the one or more computers to perform operations for selecting, from a set of actions, actions to be performed by an agent interacting with an environment to cause the agent to perform a task, wherein the operations comprise:
receiving a current observation characterizing a current environment state of the environment;
selecting an action to be performed by the agent in response to the current observation by performing multiple iterations of outer look ahead search to generate an evaluation of possible future states of the environment starting from the current environment state, wherein performing the multiple iterations of outer look ahead search comprises, in each outer look ahead search iteration:
performing an ongoing determining of a proper subset of the possible future states of the environment that is to be explored
determining that one or more inner look ahead search commencement criteria are satisfied and in response halting the ongoing determining of the proper subset; and
then, performing an inner look ahead search of only the proper subset of the possible future states of the environment, and not any remaining possible future states of the environment that are not in the proper subset, until one or more inner look ahead search termination criteria are satisfied.

14. A computed-implemented system for solving a search problem by searching through a search space comprising a plurality of candidate solutions, wherein the system comprises:
a machine learning subsystem and a search engine, wherein
the machine learning subsystem is configured to identify a proper subset of the plurality of candidate solutions, the machine learning subsystem configured to, in each current outer search iteration of multiple outer search iterations:
receive a machine learning subsystem input that includes data specifying a current subset of the plurality of candidate solutions that have already been searched in previous outer search iterations;
process the machine learning subsystem input to generate a machine learning subsystem output that includes data specifying one or more new candidate solutions that are to be searched in the current outer search iteration; and
search candidate solutions to identify a respective candidate final solution using the search engine, wherein the searched candidate solutions include the one or more new candidate solutions, and wherein
the search engine is configured to, in each current outer search iteration:
identify the respective candidate final solution to the search problem by performing a look ahead search of possible continuing solutions that start from at least the one or more new candidate solutions specified by the machine learning subsystem output, until one or more look ahead search termination criteria are satisfied, and selecting, from the plurality of candidate solutions, and as the respective candidate final solution, a selected candidate solution as a result of performing the look ahead search.

15. The system of claim 14, wherein the machine learning subsystem is further configured to, in each current outer search iteration:
maintain the data specifying the current subset of the plurality of candidate solutions that have already been searched in the previous outer search iterations, including updating the current subset of the plurality of candidate solutions by adding the one or more new candidate solutions.

16. The system of claim 14, wherein selecting the selected candidate solution as the result of performing the look ahead search comprises:
generating an evaluation result of the one or more new candidate solutions by evaluating the one or more new candidate solutions with respect to solving the search problem; and
using the evaluation results to select the selected candidate solution.

17. The system of claim 14, wherein the search engine is further configured to identify a final solution to the search problem from the respective candidate final solutions generated in the multiple outer search iterations.

18. The system of claim 14, wherein searching the candidate solutions to identify the respective candidate final solution using the search engine comprises determining that one or more look ahead search commencement criteria are satisfied.

19. The system of claim 14, wherein determining that the one or more look ahead search commencement criteria are satisfied comprises:
determining that a time spent on processing the machine learning system input to generate the machine learning subsystem output exceed a predetermined time length.

20. The system of claim 14, wherein determining that the one or more look ahead search commencement criteria are satisfied comprises:
determining that the updated current subset of the candidate solutions are sufficient in terms of generating an evaluation result of all of the plurality of candidate solutions in the search space, wherein
determining that the updated current subset of the candidate solutions are sufficient comprises:
evaluating, by computing a stopping function, the respective candidate final solution that has been identified from the updated current subset of the candidate solutions, to generate a binary classification result that specifies whether the respective candidate final solution is a valid solution to the search problem.
